(19) United States
(12) Patent Application Publication
(10) Pub. No.: US 2024/0181681 A1
(43) Pub. Date: Jun. 6, 2024

(54) A TOOL

(71) Applicant: PRODIECO LIMITED, Dublin 24 (IE)

(72) Inventors: Andrew Simon RENNICKS, Dublin 18 (IE); Colm Joseph SWEENEY, County Kildare (IE); Damien Charles O'LOUGHLIN, Dublin 12 (IE)

(73) Assignee: PRODIECO LIMITED, Dublin 24 (IE)

(21) Appl. No.: 18/285,162

(22) PCT Filed: Apr. 1, 2022
(86) PCT No.: PCT/IE2022/000003

§ 371 Date: Sep. 29, 2023

(30) Foreign Application Priority Data
Apr. 1, 2021 (IE) S2021/0070

(51) Int. Cl. B29C 33/30; B26D 1/00; B26D 7/26; B29C 51/30; B29K 105/00; B29L 31/00

(52) U.S. Cl. CPC B29C 33/305; B26D 1/0006; B26D 7/2614; B29C 51/30; B29K 2105/256; B29L 2031/7174

(57) ABSTRACT

A tool (1) for a tool holder (3) of a blister packing machine. The tool (1) comprises a body member (25) extending from a proximal front end (30) to a distal rear end (32) and defines a major engagement face (27) for abutting a corresponding abutment face (5) of the tool holder (3), and an opposite major working face (29) which acts on the material to be worked on by the tool (1). An elongated alignment member (35) extending from a proximal end (40) to a distal end (42) extends centrally along the body member (25) from a location adjacent the proximal end (30) of the body member (25) towards the distal end (32). The alignment member (35) is of T-shaped transverse cross-section having a central member (37) and a pair of side flanges (39) extending from the central member (37) for slideably engaging a corresponding T-shaped receiving groove (10) in the tool holder (3). The alignment member (35) terminates adjacent the distal end (42) thereof in an engagement member (45) defining an arcuate abutment face (48) for engaging a distal arcuate limit stop (20) in the receiving groove (10) of the tool holder (3) for locating the tool (1) in the tool holder (3). The side flanges (39) of the alignment member (35) terminate in an engagement flange (47) extending outwardly from the engagement member (45), which defines an engagement surface (55) engageable with a workface of a tension bolt (22) in the tool holder for securing the tool (1) in the tool holder (3).

The present invention relates to a tool, and in particular, though not limited, to a tool for engaging in a tool holder of the type disclosed in European Patent Specification No. 2,664,427 of Rodi.

The terms “proximal” and “front” as used in this specification are used to identify the parts of a tool and a tool holder which are closest to an operator when a tool is being inserted into a tool holder, and the terms “distal” and “rear” as used in this specification are used to identify the parts of a tool and a tool holder which are furthest away from an operator when a tool is being inserted into a tool holder.

European Patent Specification No. 2,664,429 discloses a tool and a tool holder which are particularly suitable for use in a blister packing machine, and in particular, for use in a blister packing machine for packing pharmaceutical solid dose healthcare products such as tablets, capsules and other such pharmaceutical solid dose healthcare products in respective blisters of a blister pack. Typically, a plurality of tools and tool holders are located in such blister packing machines and are spaced apart sequentially along a path aligned in the blister packing machine through which sheet film material in which the blisters are to be formed is drawn sequentially between the respective pairs of tools. Typically, the tools and tool holders are arranged in pairs, with one tool and tool holder of each pair located below the film material, and the other tool and tool holder located above the film material, so that each pair of tools carry out respective operations on the film material as the film material is drawn sequentially through the respective pairs of tools. Typically, two sheets of film material are drawn between the respective pairs of tools. The blisters are formed in the lower one of the two films, and on the pharmaceutical solid dose healthcare products being deposited in the formed blisters, the upper film is then sealably secured to the lower film for sealing the pharmaceutical solid dose healthcare products in the respective blisters.

Typically, the first of the pair of tools in the sequence is a pair of forming tools which are adapted to form the blisters in the lower film. The lower film with the blisters formed therein is then drawn beneath a feeding station from which the pharmaceutical solid dose healthcare products are dispensed into the respective blisters. The upper sheet of the film material is then brought into engagement with the lower film and is sealably secured to the lower film by the next pair of tools in the sequence. Thereafter, the two sheets of film material which have now been sealed together are then drawn sequentially through a series of pairs of tools which carry out further operations, such as embossing codes and a pattern on the sealed sheets of film material, forming perforations in the sealed sheets of film material to facilitate subsequent separation of the blisters from the blister pack, punching and cutting for severing groups of blisters from the remaining blisters. The lower film may comprise a film of plastics material or a film of metal foil material, for example, aluminium foil. The upper sheet of film material may comprise a film of plastics material, a film of paper material or indeed another film of aluminium foil or other metal foil material. Such blister packing machines and tools and tool holders therefor will be well known to those skilled in the art.

While the tool and tool holder combination disclosed in European Patent Specification No. 2,664,429 provides an arrangement for securing and aligning the tool with the tool holder, unfortunately, inserting the tool into the tool holder can be quite problematical, since the tool is free to pivot from side to side about a clamping bolt relative to the tool holder as the tool is being entered into the tool holder. In fact, the tool is free to pivot about the clamping bolt, until the tool has been almost fully inserted into the tool holder.

This, is undesirable, and there is therefore a need for a tool which addresses this problem.

The present invention is directed towards providing a tool which addresses this problem, and which maintains the tool substantially in alignment with the tool holder from commencement of insertion of the tool into the tool holder.

According to the invention there is provided a tool for engaging a tool holder, the tool holder defining an abutment face, and having an elongated receiving groove of T-shape transverse cross-section formed into the abutment face of the tool holder and extending into the tool holder from a proximal end of the tool holder and terminating in the tool holder in a distal end defining a distal arcuate limit stop, and a tension bolt having an inclined work face and being located in the tool holder to one side of the receiving groove and spaced apart proximally from the distal arcuate limit stop thereof and being urgeable into the tool holder for securing a tool to the tool holder, the tool comprising a body member defining a major working face of the tool and a major engagement face of the tool, the working face and the engagement face of the tool facing in opposite directions away from each other, the engagement face being adapted to abut the abutment face of the tool holder, an alignment means mounted on the engagement face of the tool and adapted to engage the receiving groove in the tool holder for aligning the tool with the tool holder in a direction transversely of the receiving groove, and an engagement member mounted on and extending from the engagement face of the tool and terminating in an engagement flange extending outwardly therefrom and spaced apart from the engagement face of the tool, the engagement flange defining an engagement surface facing the engagement face of the tool and diverging therefrom, the engagement surface of the engagement flange being adapted to engage the work face of the tension bolt, one of the engagement member and the engagement flange thereof being adapted to engage the distal arcuate limit stop of the receiving groove, so that with the alignment means, the engagement member and the engagement flange thereof in the receiving groove and the engagement member adjacent the distal end of the receiving groove, on the tension bolt being urged into the tool holder with the work face thereof in engagement with the engagement surface of the engagement flange the tool is secured in the tool holder with the engagement face of the tool in tight abutting engagement with the abutment face of the tool holder and the one of the engagement member and the engagement flange urged into tight engagement with the distal arcuate limit stop of the receiving groove with the tool aligned in the tool holder.

Preferably, the alignment means defines an alignment plane extending perpendicularly from the engagement face of the tool, the alignment means being adapted to engage the receiving groove of the tool holder with the alignment plane aligned with the receiving groove.

In one embodiment of the invention the alignment means is located on the engagement face of the tool relative to the working face thereof, so that when the tool is secured in the tool holder, the working face of the tool is aligned in position relative to the tool holder.

In another embodiment of the invention the engagement member is located on the engagement face of the tool relative to the working face thereof, so that when the tool is secured in the tool holder, the working face of the tool is aligned in position relative to the tool holder.

Preferably, the alignment means is adapted to slideably engage the receiving groove.

In another embodiment of the invention the engagement member is slideable in the receiving groove.

In a further embodiment of the invention the engagement flange of the engagement member is slideable in the receiving groove.

In one embodiment of the invention one of the engagement member and the engagement flange thereof defines an abutment surface for engaging the distal arcuate limit stop of the receiving groove of the tool holder.

Advantageously, the abutment surface defined by the one of the engagement member and the engagement flange thereof is defined as an arcuate abutment surface.

Preferably, the arcuate abutment surface defined by the one of the engagement member and the engagement flange thereof defines a centre of radius, and preferably, the centre of radius coincides with a main axis extending perpendicularly from the engagement face of the tool.

Preferably, the engagement member is located on the engagement face of the tool with the main axis lying in the alignment plane defined by the alignment means.

In one embodiment of the invention the engagement surface of the engagement flange is located proximally of a transverse plane containing the main axis and extending transversely of the alignment plane defined by the alignment means.

In another embodiment of the invention of the engagement surface of the engagement flange is located to one side of the alignment plane defined by the alignment means, and preferably, spaced apart therefrom.

In a further embodiment of the invention the engagement surface of the engagement flange is located to lie on a straight line joining the main axis with a central geometric axis defined by the tension bolt in the tool holder when the tool is secured in the tool holder.

In one embodiment of the invention the engagement flange extends partly around the engagement member.

In another embodiment of the invention the alignment means comprises an elongated alignment member defining the alignment plane and extending from and along the engagement face of the tool. Preferably, the alignment member extends from a proximal end to a distal end.

In one embodiment of the invention the engagement member is located distally of the alignment member, and preferably, the engagement member is located one of adjacent the distal end of the alignment member, and spaced apart distally from the distal end of the alignment member.

Preferably, the engagement member is located adjacent the distal end of the alignment member, and advantageously, the distal end of the alignment member terminates in the engagement member.

Preferably, the alignment member and the engagement member are formed as a single integral unit.

In another embodiment of the invention the alignment member comprises an elongated member of T-shape cross-section having a central member extending from and longitudinally along the face of the tool, and advantageously, a pair of side flanges extend outwardly from the central member on respective opposite sides thereof spaced apart from the engagement face of the tool.

In another embodiment of the invention the distal end of the central member of the alignment member forms the engagement member.

In another embodiment of the invention the distal end of the side flanges of the alignment member terminate in the engagement flange of the engagement member.

In one embodiment of the invention the distal end of the side flange of the alignment member on one side thereof adjacent the engagement flange is relieved inwardly towards the central member to accommodate engagement of the tension bolt with the engagement surface of the engagement flange.

Preferably, the engagement flange defines an outer arcuate peripheral edge adjacent the engagement surface thereof.

Preferably, the central member of the alignment member is slideable in the receiving groove of the tool holder.

In another embodiment of the invention the side flanges of the alignment member are slideable in the receiving groove of the tool holder.

In another embodiment of the invention the central member of the alignment member defines a locating portion adjacent the proximal end thereof, the locating portion being adapted to engage a locating portion of the entry slot of the receiving groove of the tool holder for aligning the alignment member with the receiving groove. Preferably, the locating portion of the central member of the alignment member is adapted to engage the locating portion of the entry slot of the receiving groove of the tool holder with a snug sliding fit.

In one embodiment of the invention the locating portion extends longitudinally along the central member of the alignment member a distance of at least 5 mm, and preferably, a distance of at least 10 mm, and advantageously, a distance of approximately 13 mm.

In another embodiment of the invention the locating portion extends from the proximal end of the central member of the alignment member.

Preferably, the locating portion is of width in a transverse direction relative to the alignment plane greater than the transverse width of the central member of the alignment member from the distal end of the locating portion to the distal end of the central member.

Preferably, the locating portion of the central member of the alignment member extends from the engagement face of the tool, and advantageously, extends to the respective side flanges of the alignment member. Ideally, the locating portion of the central member of the alignment member is symmetrical about the alignment plane.

Preferably, the locating portion of the central member of the alignment member defines opposite locating faces thereof slideably and snugly engageable with corresponding faces of the entry slot of the receiving groove of the tool holder adjacent the proximal end thereof.

In one embodiment of the invention the body member of the tool extends longitudinally from a proximal end to a distal end, and preferably, the proximal end of the alignment member substantially coincides with the proximal end of the body member of the tool.

In another embodiment of the invention the distal end of the alignment member is located intermediate the proximal and distal ends of the body member of the tool.

In one embodiment of the invention the alignment member, including the engagement member and the engagement flange are of metal material, and preferably, of tool steel, and advantageously, of premium tool steel, and ideally, the material of the alignment member including the engagement member and the engagement flange are hardened. Preferably, the surfaces defined by the alignment member, the engagement member and the engagement flange are polished.

In another embodiment of the invention the alignment means comprises a plurality of alignment pins extending from the abutment face of the tool and spaced apart along and defining the alignment plane, the alignment pins being adapted to engage the receiving groove of the tool holder.

Preferably, the alignment pins extend perpendicularly from the engagement face of the tool.

In one embodiment of the invention the alignment pins are slideably engageable in the receiving groove of the tool holder.

In one embodiment of the invention the alignment means is adapted to cooperate with the receiving groove of the tool holder during entry of the tool in the tool holder for guiding the tool into the tool holder with the alignment means aligned with the receiving groove. Preferably, the alignment means is adapted to cooperate with the receiving groove of the tool holder for aligning the tool with the tool holder from the commencement of entry of the alignment means into the tool holder, and advantageously, from the commencement of engagement of the engagement member with the receiving groove of the tool holder.

In one embodiment of the invention the main axis defined by the engagement member coincides with the centre of a working area of the working face of the tool.

In another embodiment of the invention the working area of the working face of the tool comprises or is adapted to receive formations or components for forming, shaping or otherwise working a sheet of material to be formed, shaped or worked by the tool.

In another embodiment of the invention the tool is adapted for forming, shaping or working a film material, for example, a film material used in the blister packing of products, and in one embodiment of the invention the working area of the working face of the tool is adapted to form, shape or work film material for use in the blister packing of pharmaceutical, surgical and/or medical products.

Additionally, the invention provides a pair of the tools configured to cooperate with each other in the forming, shaping or working material by the working faces of the respective tools.

In another embodiment of the invention the tools are adapted to engage respective spaced apart tool holders with the tools configured to accommodate the material to be formed, shaped or worked therebetween.

In one embodiment of the invention the tools are adapted for engaging a corresponding pair of tool holders in a blister packing machine.

In another embodiment of the invention the tools are adapted for engagement with a pair of tool holders of a blister packing machine for packing pharmaceutical solid dose healthcare products.

The advantages of the invention are many. Firstly, the alignment member on entry into the receiving groove cooperates with the receiving groove to guide the tool into the tool holder with the alignment member aligned with the receiving groove. This guiding cooperating action between the alignment member and the receiving groove essentially commences on entry of the alignment member into the receiving groove, so that during entry of the tool into the tool holder the tool is positively guided into the tool holder with the alignment member aligned and engaging the receiving groove. Accordingly, the tool is maintained in positive alignment with the tool holder during the entry of the tool into the tool holder, without any transverse movement of the tool relative to the receiving groove of the tool holder, in other words, without any side-to-side movement of the tool relative to the tool holder. Secondly, due to the fact that the alignment member extends substantially the length of the receiving groove, once the tool has been fully entered into the tool holder with the engagement member abutting the distal arcuate limit stop of the receiving groove, the tool is positively located in the tool holder by the alignment member.

A further advantage of the tool according to the invention is achieved by the provision of the alignment member as being an elongated alignment member terminating in the engagement member, in that the tool can be readily easily guided into the platten of the tool holder, and can be readily easily positioned therein without the tool wobbling from side-to-side.

A further advantage of the tool according to the invention is that by providing the alignment member and the engagement member, as well as the side flanges and the engagement flange being of hardened premium tool steel, the alignment member as well as the engagement member and the side and engagement flanges are substantially wear resistant, and therefore, replacement of these components is seldom required.

By virtue of the fact that the exposed surfaces of the alignment member and the engagement member, as well as the side and engagement flanges are polished, a further advantage of the invention is achieved in that the tool may be entered readily easily and smoothly into the platten of the tool holder.

The invention will be more clearly understood from the following description of a preferred embodiment thereof which is given by way of example only with reference to the accompanying drawings, in which:

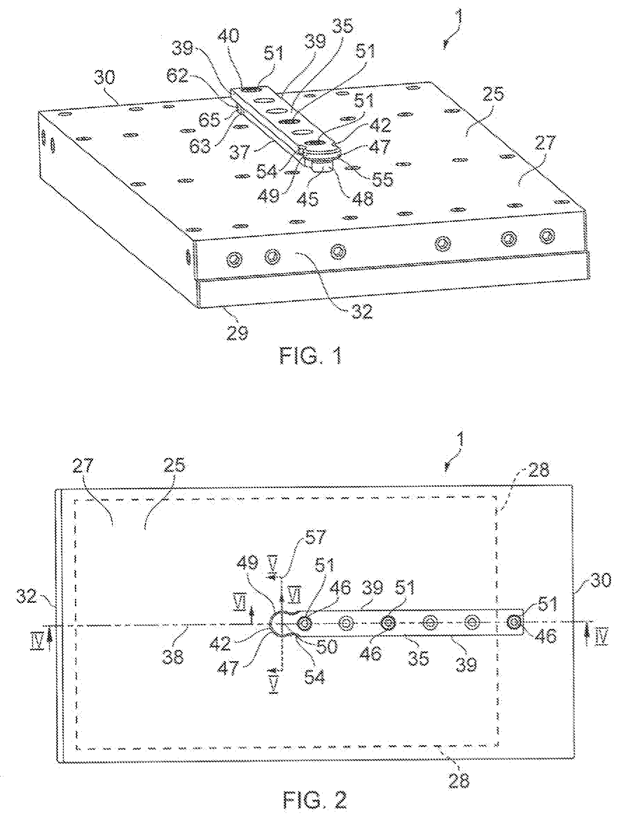

FIG. 1 is a perspective view of a tool according to the invention viewed from the rear or distal end thereof,

FIG. 2 is a top plan view of the tool of FIG. 1,

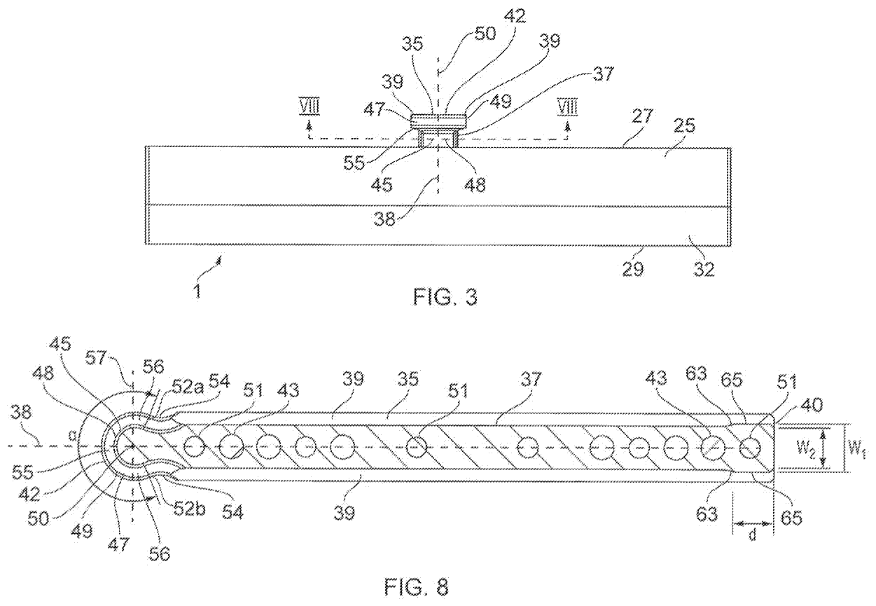

FIG. 3 is a rear end elevational view of the tool of FIG. 1,

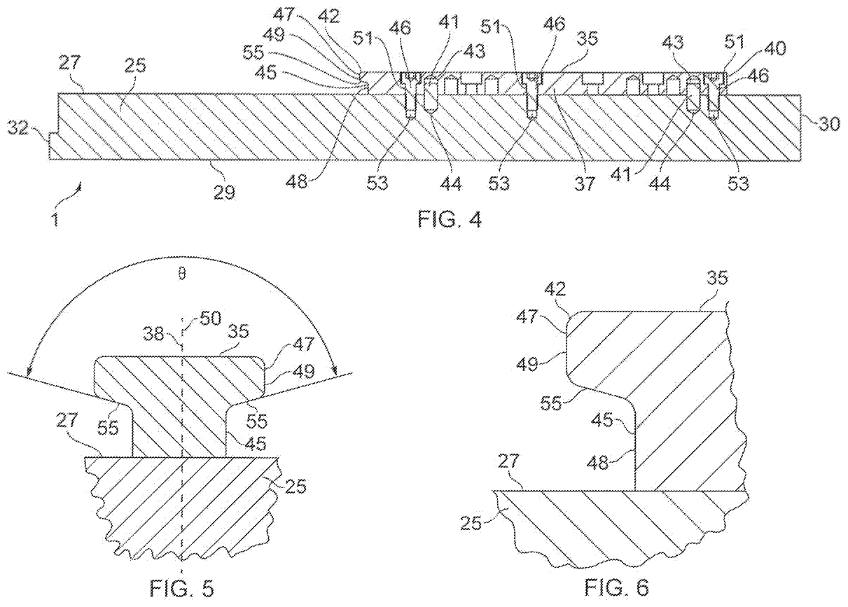

FIG. 4 is a cross-sectional side elevational view of the tool of FIG. 1 on the line IV-IV of FIG. 2,

FIG. 5 is an enlarged cross-sectional front end elevational view of a detail of the tool of FIG. 1 on the line V-V of FIG. 2,

FIG. 6 is an enlarged cross-sectional side elevational view of a detail of the tool of FIG. 1 on the line VI-VI of FIG. 2,

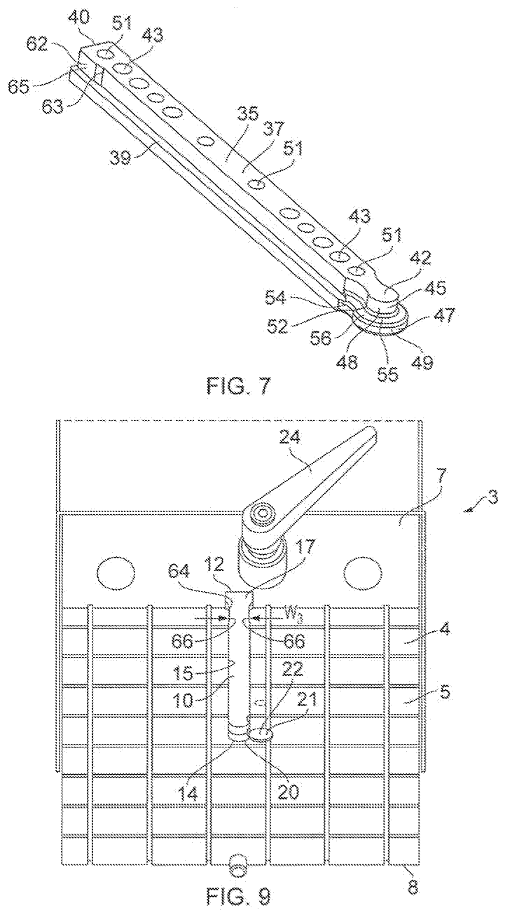

FIG. 7 is a perspective view of a detail of the tool of FIG. 1,

FIG. 8 is a cross-sectional underneath plan view of the detail of FIG. 7 on the line VIII-VIII of FIG. 3,

FIG. 9 is an underneath perspective view of a portion of a tool holder into which the tool of FIG. 1 is engageable,

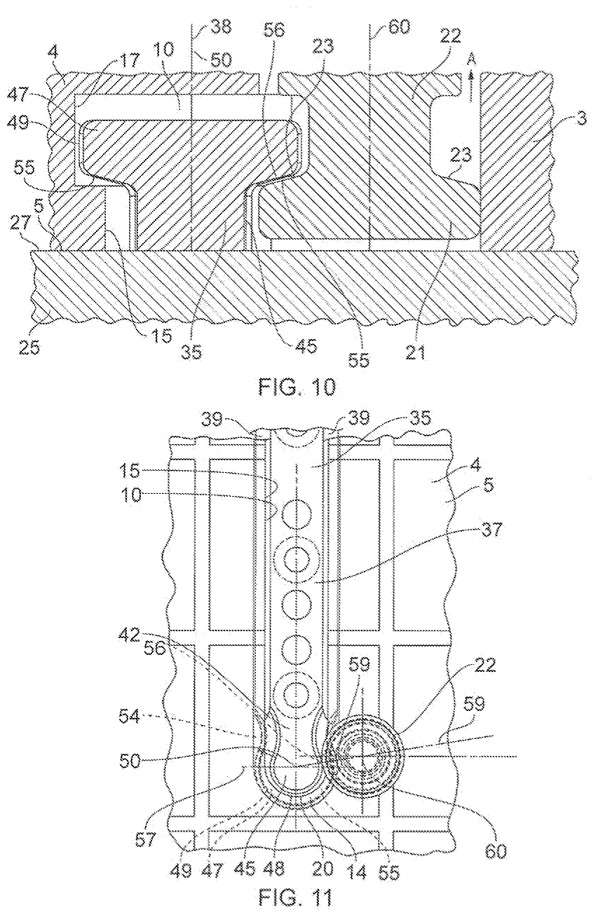

FIG. 10 is a cross-sectional front end elevational view of a detail of the tool of FIG. 1 being engaged in the tool holder of FIG. 9, and

FIG. 11 is an underneath plan view of a portion of the tool of FIG. 1 being engaged in the tool holder of FIG. 9.

Referring to the drawings there is illustrated a tool according to the invention indicated generally by the reference numeral 1 for engaging and securing in a tool holder indicated generally by the reference numeral 3 of the type disclosed in European Patent Specification No. 2,664,429. Before describing the tool 1, the parts of the tool holder 3 relevant to the tool 1 will first be described.

Referring to FIGS. 9 to 11, the tool holder 3 comprises a platten 4 which defines an abutment face 5 against which the tool 1 is secured as will be described below. The platten 4 extends from a proximal front end 7 to a rear distal end 8. An elongated rectilinear receiving groove 10 of T-shape cross-section extending between a proximal end 12 and a distal end 14 extends into the platten 4 from the abutment face 5 thereof, and along the platten 4 from the proximal front end 7 thereof towards the distal rear end 8. However, the receiving groove 10 terminates in its distal end 14 intermediate the proximal front end 7 and the distal rear end 8 of the platten 4. The receiving groove 10 comprises an elongated entry slot 15 and undercut slots 17 extending in the platten 4 on opposite sides of the entry slot 15, and with which the entry slot 15 communicates. The entry slot 15 terminates at the distal end 14 of the receiving groove 10 in a distal arcuate limit stop 20 for a purpose to be described below. The undercut slots 17 join beneath the distal arcuate limit stop 20, and extend distally into the platten 14 beneath the distal arcuate limit stop 20. A tension bolt 22 located in the platten 4 is located adjacent the receiving groove 10 but to one side thereof, and is spaced apart proximally from the distal arcuate limit stop 20 defined by the distal end 14 of the receiving groove 10. The tension bolt 22 terminates in a head 21 which defines an inclined work face 23, and is urgeable into the platten 4 in the direction of the arrow A by a lever 24 extending from the proximal front end 7 of the platten 4 for securing a tool in the platten 4 of the tool holder 3, as is described in European Patent Specification No. 2,664,429.

Turning now to the tool 1, the tool 1 comprises a body member 25 extending between a proximal front end 30 and a distal rear end 32 and defining a major engagement face 27 and an opposite major working face 29. The engagement face 27 of the tool 1 is adapted to tightly abut the abutment face 5 of the platten 4 of the tool holder 3 when the tool 1 is secured in the tool holder 3 as will be described below. The working face 29 of the tool 1 defines a working area 28 illustrated in broken lines in FIG. 2, which is the area of the working face 29 which acts on material to be formed, shaped or otherwise worked on by the tool 1.

Typically, the tool 1 will be provided as one of a pair of tools, and typically, each tool will comprise a major engagement face 27 and a major working face 29. The working faces 29 of the respective tools will each comprise a working area 28, and the working areas of the respective tools 1 will be complementary to each other. A pair of the tool holders 3 aligned with each other, typically, will comprise respective plattens 4 spaced apart from each other with the abutment faces 5 thereof facing each other for receiving the respective tools 1 with the engagement faces 27 of the respective tools abutting the abutment faces 5 of the respective plattens 4 of the tool holders 3, and the working faces 29 of the tools 1 facing each other. The working areas 28 of the working faces 29 of the tools 1 may be adapted for forming, shaping, cutting, punching, sealing or otherwise working on material engaged between the working faces 29. The working areas 28 of the working faces 29 of the tools 1 may either comprise or be adapted to carry forming, shaping, cutting, punching, sealing and other working elements for forming, shaping or working on the material.

The arrangement and working of a pair of such tools 1 secured to a pair of plattens 4 of a tool holder is described in European Patent Specification No. 2,664,429, and further description of this aspect of the operation of a pair of the tools 1 located in the tool holder 3 should not be required.

The material for which a pair of the tools 1 may be adapted to work on may be any sheet film material. However, in this embodiment of the invention the tools 1 are adapted for use in a blister packing machine in which pharmaceuticals, for example, solid dose pharmaceuticals, such as tablets, capsules and the like, are blister packed in blisters formed in either or both plastics film material and metal foil material, where the plastic film material and/or metal foil material are drawn along a path sequentially through spaced apart pairs of the tools in the blister packing machine from respective rolls thereof, and the foil and/or film materials are worked on by the tools.

An alignment means, in this embodiment of the invention an elongated alignment member 35 of T-shape transverse cross-section extending between a proximal end 40 and a distal end 42 is mounted on the engagement face 27 of the tool 1 with the alignment member 35 aligned with the working face 29 of the tool 1. The alignment member 35 is adapted to freely slideably engage the receiving groove 10 in the platten 4 of the tool holder 3 for aligning the tool 1, and in turn the working face 29 thereof with the tool holder 3 in a transverse direction relative to the receiving groove 10 and the alignment member 35. The alignment member 35 comprises a central member 37 extending perpendicularly from and along the engagement face 27 of the tool 1 and defines a central longitudinally extending alignment plane 38, which when the tool 1 is secured in the platten 4 of the tool holder 3 is aligned with the receiving groove 10 of the platten 4. Dowels 41 in bores 43 extending into the central member 37 of the alignment member 35 and in bores 44 extending into the body member 25 locate the alignment member 35 on the body member 25 with the alignment member 35 aligned with the working face 29 of the tool 1. Screws 46 extending through countersunk bores 51 in the alignment member 35 engage threaded bores 53 in the body member 25 for securing the alignment member 35 to the engagement face 27 of the body member 25.

A pair of side flanges 39 extend along and sidewardly outwardly from the central member 37 from respective opposite sides thereof. The side flanges 39 are spaced apart from the engagement face 27 of the tool 1. In this embodiment of the invention the proximal end 40 of the alignment member 35 is located adjacent or close to the proximal front end 30 of the body member 25, and the distal end 42 of the alignment member 35 terminates intermediate the proximal front end 30 and the distal rear end 32 of the tool 1.

The distal end 42 of the central member 37 of the alignment member 35 terminates in and forms an engagement member 45. The side flanges 39 of the alignment member 35 adjacent the distal end 42 thereof terminate in an engagement flange 47 extending outwardly from and partly around the engagement member 45 spaced apart from the engagement face 27 of the tool 1. The engagement flange 47 defines a partly circular outer peripheral edge 49.

The engagement member 45 defines an arcuate abutment surface 48 for engaging the distal arcuate limit stop 20 of the receiving groove 10 in the platten 4 of the tool holder 3 as will be described below. The arcuate abutment surface 48 of the engagement member 45 defines a centre of radius coinciding with a main axis 50 extending perpendicularly to the engagement face 27 of the tool 1, and lying in the alignment plane 38 defined by the central member 37. In this embodiment of the invention the main axis 50 defined by the arcuate abutment surface 48 of the engagement member 45 coincides with the centre of the working area of the working face 29 of the tool 1 for centrally aligning the working area of the working face of the tool 1 with the tool holder 3.

The engagement flange 47 of the engagement member 45 is symmetrical about the alignment plane 38 and extends around the main axis 50 through an angle α of approximately 230°, and terminates on respective opposite sides of the alignment plane 38 at opposite ends 52a and 52b. The peripheral edge 49 of the engagement flange 47 adjacent the respective opposite ends 52a and 52b thereof terminate in concave arcuate portions 54 which merge into the side flanges 39 of the alignment member 35, and thereby relieve the side flanges 39 inwardly, for a purpose to be described below.

The engagement flange 47 defines an engagement surface 55 which is spaced apart from and faces the engagement face 27 of the tool 1. The engagement surface 55 extends from the engagement member 45 and diverges relative to the engagement face 27 of the tool 1. In this embodiment of the invention the engagement surface 55 extends around the engagement flange 47 through the angle α of 230°, and is of partly conical shape defining a cone angle θ. The cone angle θ defined by the engagement surface 55 is dictated by a cone angle defined by the work face 23 defined by the head 21 of the tension bolt 22, and is substantially similar to the cone angle defined by the work face 23 of the tension bolt 22. In this embodiment of the invention the cone angle θ defined by the engagement surface 55 is approximately 150°. The engagement surface 55 of the engagement flange 47 is adapted to engage the work face 23 of the tension bolt 22 in the platten 4 of the tool holder 3, so that when the work face 23 of the tension bolt 22 is in engagement with the engagement surface 55 of the engagement flange 47, and the tension bolt 22 is urged into the platten 4 in the direction of the arrow A, see FIG. 10, by the lever 24, the tool 1 is secured in alignment with the tool holder 3, as will be described in more detail below.

While in this embodiment of the invention the engagement surface 55 has been described as extending around the engagement flange 47 between the ends 52a and 52b, this is not essential. It is only necessary that the engagement surface 55 be provided on the engagement flange 47 at a location 56 proximal of a transverse line 57 extending through the main axis 50 and transversely of the alignment plane 38, so that when the alignment member 35 is engaged in the receiving groove 10 of the platten 4 with the arcuate abutment surface 48 of the engagement member 45 engaging the distal arcuate limit stop 20 of the receiving groove 10, a straight line 59 joining the main axis 50 and a central geometric axis 60 of the tension bolt 22 should lie on the engagement surface 55. This enables the work face 23 of the tension bolt 22 to engage the engagement surface 55 of the engagement flange 47 with line contact along the line 59 when the tension bolt 22 is urged into engagement with the engagement flange 47. By providing the engagement surface 55 extending around the engagement flange 47, and in particular, on the opposite sides of the alignment plane 38, and proximal of the transverse line 57, the engagement surface 55 of the engagement flange 47 is engageable with the work face 23 of the tension bolt 22, irrespective of which side of the receiving groove 10 the tension bolt 22 is located in the tool holder 3. The relieved portions of the side flanges 39 formed by the arcuate concave portions 54 thereof, permit engagement of the work face 23 of the tension bolt 22 with the engagement surface 55 of the engagement flange 47 without interference from the side flanges 39 of the alignment member 35.

Accordingly, when the tool 1 is engaged in the platten 4 of the tool holder 3 with the alignment member 35 engaged in the receiving groove 10 and with the arcuate abutment surface 48 of the engagement member 45 abutting the distal arcuate limit stop 20 of the receiving groove 10, the action of the work face 23 of the tension bolt 22 on the engagement surface 55 of the engagement flange 47 when the tension bolt 22 is being urged into the platten 4 in the direction of the arrow A by the lever 24 urges the engagement face 27 of the tool 1 into tight abutting engagement with the abutment face 5 of the platten 4, and simultaneously urges the arcuate abutment surface 48 into tight abutting engagement with the distal arcuate limit stop 20 of the receiving groove 10 of the tool holder 3, and urges the alignment member 35 into tight alignment engagement with the receiving groove 10, so that the tool 1 is tightly and securely engaged in the tool holder 3 and fully aligned with the tool holder 3.

The central member 37 of the abutment member 35 adjacent the proximal end 40 thereof defines a locating portion 62, which extends distally from the proximal end 40 thereof a distance d of approximately 13 mm, and terminates at a distal end 63. The locating portion is adapted to slideably but snugly engage a corresponding locating portion 64 of the entry slot 15 of the receiving groove 10 for aligning the alignment member 35 with the receiving groove 10, and in turn for aligning the tool 1 with the tool holder 3 in a transverse direction relative to the receiving groove 10. The locating portion 62 is symmetrical about the alignment plane 38 and defines respective opposite locating faces 65 which slideably and snugly engage corresponding faces 66 of the locating portion 64 of the entry slot 15 of the receiving groove 10. The locating faces 65 extend from the proximal end 40 of the central member 37 the distance d and extend between the engagement face 27 of the tool 1 and the corresponding side flanges 39 of the alignment member 35. The width W₁ of the locating portion 62 between the locating faces 65 is slightly greater than the remaining width W₂ of the central member 37 from the distal end 63 of the locating portion 62 to the distal end 42 of the central member 37. The width W₁ of the locating portion 62 is just less than the width W₃ between the corresponding faces 66 of the locating portion 64 of the receiving groove 10, see FIG. 9, so that the locating portion 62 slideably and snugly engages the locating portion 64 of the receiving groove 10 with the alignment member 35 aligned in the receiving groove 10.

In this embodiment of the invention the body member 25 of the tool 1 is of metal material, and the alignment member 35, including the central member 37, the side flanges 39, the engagement member 45 and the engagement flange 47 are of hardened premium tool steel with the exposed surfaces thereof polished.

In use, the tool 1 is engaged in the tool holder 3 by entering the distal end 42 of the alignment member 35 into the proximal end 12 of the receiving groove 10 in the platten 4 of the tool holder 3, and urging the tool 1 distally relative to the platten 4 until the arcuate abutment surface 48 of the engagement member 45 abuts the distal arcuate limit stop 20 of the receiving groove 10, and the locating portion 62 of the central member 37 of the alignment member 35 engages in the locating portion 64 of the entry slot 15 of the receiving groove 10 of the tool holder 3. At that stage the portion 56 of the engagement surface 55 of the engagement flange 47 is overlapped by a portion of the work face 23 of the head 21 of the tension bolt 22. The tension bolt 22 is urged into the platten 4 in the direction of the arrow A by the lever 24 to urge the work face 23 of the tension bolt 22 into engagement with the engagement surface 55 of the engagement flange 47. Further urging of the tension bolt 22 into the platten 4 urges the engagement face 27 of the tool 1 into tight abutting engagement with the abutment face 5 of the platten 4 of the tool holder 3, while simultaneously urging the arcuate abutment surface 48 of the engagement member 45 into tight abutting engagement with the distal arcuate limit stop 20 of the receiving groove 10, and urging the locating portion 62 of the alignment member 35 further into the locating portion 64 of the entry slot 15 of the receiving groove 10, so that the alignment member 35 is aligned with the alignment groove 10. Thus, the tool 1 is tightly and securely engaged in the tool holder 3 and aligned therewith. The alignment of the tool 1 in the tool holder 3 automatically aligns the working area 28 of the working face 29 of the tool relative to the tool holder.

By virtue of the fact that the alignment member 35 of the tool 1 is in continuous engagement with the receiving groove 10 of the tool holder 3 from commencement of inserting of the tool 1 into the tool holder 3, as the tool 1 is being inserted into the tool holder 3, the cooperating action between the alignment member 35 and the receiving groove 10 guides the tool 1 into the tool holder 3 and maintains the tool 1 in alignment with the tool holder 3 as the tool 1 is being inserted into the tool holder 3, thereby avoiding any transverse or side-to-side movement of the tool 1 relative to the receiving groove 10 of the tool holder 3 during insertion of the tool 1 into the tool holder 3.

As discussed above, in practice two tools 1, the working faces 29 of which will be complementary to each other will be provided with respective alignment members 35 appropriately aligned on the engagement faces 27 of the tools 1, so that when the two tools 1 are engaged in respective opposite plattens 4 of the respective tool holders 3, the working faces 29 of the respective tools 1 will be aligned with each other, provided that the receiving grooves 10 in the plattens 4 are properly aligned with each other.

While the alignment means for aligning the tool with the tool holder has been described as comprising an elongated alignment member of T-shape cross-section, while it is advantageous to provide the alignment member of T-shape cross-section, it is not essential that the alignment member be of T-shape cross-section. The alignment member may be provided with the central member only. Additionally, while it is desirable that the central member 37 should terminate in the engagement member 45, this is not essential. The engagement member may be provided separate from the alignment member, and in fact, may be provided spaced apart distally from the alignment member. However, it would be important that the engagement member should lie on the alignment plane defined by the alignment member.

It is also envisaged that while the alignment means has been described as comprising an elongated alignment member, in some embodiments of the invention it is envisaged that the alignment means may be provided by at least two alignment members such as alignment pins which would be mounted on the engagement face of the tool and would extend therefrom, and would together define the alignment plane. The alignment pins would be spaced apart along the alignment plane between the engagement member and the proximal end of the tool.

Furthermore, it is envisaged that instead of providing a single alignment member, a plurality of spaced apart alignment members may be provided, which would be aligned with each other and would define the alignment plane.

While the central member of the alignment member has been described as comprising a locating portion of width greater than the remaining width of the central member, while this is desirable, it is not essential. While the alignment member has been described with the proximal end thereof located adjacent the proximal front end of the body member of the tool, while this is desirable, it is not essential. The alignment member need not extend fully to the proximal front end of the body member of the tool.

While the engagement member 45 has been described as having an arcuate abutment surface 48, it is envisaged in some embodiments of the invention that the engagement member 45 may be of circular transverse cross-section and the distally facing portion of the engagement member of circular transverse cross-section would define the arcuate abutment surface 48. It will also be appreciated that when the engagement member 45 is provided to be of circular transverse cross-section, the engagement flange 47 may extend completely around the engagement member, and the engagement surface 55 thereof may define a cone.

While the tool according to the invention has been described for use in a blister packing machine for packing pharmaceutical solid dose healthcare products such as tablets, capsules and the like, it will be readily apparent to those skilled in the art that the tool may be used in any blister packing machine for blister packing any product be they pharmaceutical products or otherwise. Needless to say, it will also be readily apparent to those skilled in the art that the tool according to the invention may be used in any compatible tool holder irrespective of the material to be formed by the tool.

1-57. (canceled)

58. A tool for engaging a tool holder, the tool holder defining an abutment face, and having an elongated receiving groove of T-shape transverse cross-section formed into the abutment face of the tool holder and extending into the tool holder from a proximal end of the tool holder and terminating in the tool holder in a distal end defining a distal arcuate limit stop, and a tension bolt having an inclined work face and being located in the tool holder to one side of the receiving groove and spaced apart proximally from the distal arcuate limit stop thereof and being urgeable into the tool holder for securing a tool to the tool holder, the tool comprising a body member defining a major working face of the tool and a major engagement face of the tool, the working face and the engagement face of the tool facing in opposite directions away from each other, the engagement face being adapted to abut the abutment face of the tool holder, an alignment means mounted on the engagement face of the tool and adapted to engage the receiving groove in the tool holder for aligning the tool with the tool holder in a direction transversely of the receiving groove, and an engagement member mounted on and extending from the engagement face of the tool and terminating in an engagement flange extending outwardly therefrom and spaced apart from the engagement face of the tool, the engagement flange defining an engagement surface facing the engagement face of the tool and diverging therefrom, the engagement surface of the engagement flange being adapted to engage the work face of the tension bolt, one of the engagement member and the engagement flange thereof being adapted to engage the distal arcuate limit stop of the receiving groove, so that with the alignment means, the engagement member and the engagement flange thereof in the receiving groove and the engagement member adjacent the distal end of the receiving groove, on the tension bolt being urged into the tool holder with the work face thereof in engagement with the engagement surface of the engagement flange the tool is secured in the tool holder with the engagement face of the tool in tight abutting engagement with the abutment face of the tool holder and the one of the engagement member and the engagement flange urged into tight engagement with the distal arcuate limit stop of the receiving groove with the tool aligned in the tool holder.

59. A tool as claimed in claim 58 in which the alignment means defines an alignment plane extending perpendicularly from the engagement face of the tool, the alignment means being adapted to engage the receiving groove of the tool holder with the alignment plane aligned with the receiving groove, and preferably, the alignment means is located on the engagement face of the tool relative to the working face thereof, so that when the tool is secured in the tool holder, the working face of the tool is aligned in position relative to the tool holder.

60. A tool as claimed in claim 58 in which the alignment means is adapted to slideably engage the receiving groove.

61. A tool as claimed in claim 58 in which the alignment means comprises an elongated alignment member defining the alignment plane and extending from and along the engagement face of the tool, and preferably, the alignment member extends from a proximal end to a distal end, and advantageously, the alignment member comprises an elongated member of T-shape cross-section having a central member extending from and longitudinally along the face of the tool, and preferably, the central member of the alignment member is slideable in the receiving groove of the tool holder, and advantageously, a pair of side flanges extend outwardly from the central member on respective opposite sides thereof spaced apart from the engagement face of the tool, and preferably, the side flanges of the alignment member are slideable in the receiving groove of the tool holder.

62. A tool as claimed in claim 58 in which the engagement member is located on the engagement face of the tool relative to the working face thereof, so that when the tool is secured in the tool holder, the working face of the tool is aligned in position relative to the tool holder, and preferably, the engagement member is slideable in the receiving groove, and advantageously, the engagement flange of the engagement member is slideable in the receiving groove.

63. A tool as claimed in claim 58 in which one of the engagement member and the engagement flange thereof defines an abutment surface for engaging the distal arcuate limit stop of the receiving groove of the tool holder, and preferably, the abutment surface defined by the one of the engagement member and the engagement flange thereof is defined as an arcuate abutment surface, and preferably, the arcuate abutment surface defined by the one of the engagement member and the engagement flange thereof defines a centre of radius, and advantageously, the centre of radius coincides with a main axis extending perpendicularly from the engagement face of the tool, and preferably, the engagement member is located on the engagement face of the tool with the main axis lying in the alignment plane defined by the alignment means.

64. A tool as claimed in claim 58 in which the engagement surface of the engagement flange is located proximally of a transverse plane containing the main axis and extending transversely of the alignment plane defined by the alignment means, and preferably, the engagement surface of the engagement flange is located to one side of the alignment plane defined by the alignment means, and advantageously, the engagement surface of the engagement flange is located spaced apart from the alignment plane defined by the alignment means.

65. A tool as claimed in claim 58 in which the engagement surface of the engagement flange is located to lie on a straight line joining the main axis with a central geometric axis defined by the tension bolt in the tool holder when the tool is secured in the tool holder, and preferably, the engagement flange extends partly around the engagement member, and preferably, the engagement member is located distally of the alignment member.

66. A tool as claimed in claim 58 in which the engagement member is located one of adjacent the distal end of the alignment member, and spaced apart distally from the distal end of the alignment member, and preferably, the engagement member is located adjacent the distal end of the alignment member, the distal end of the alignment member terminating in the engagement member, and preferably, the alignment member and the engagement member are formed as a single integral unit, and advantageously, the distal end of the central member of the alignment member forms the engagement member.

67. A tool as claimed in claim 58 in which the distal end of the side flanges of the alignment member terminate in the engagement flange of the engagement member, and preferably, the distal end of the side flange of the alignment member on one side thereof adjacent the engagement flange is relieved inwardly towards the central member to accommodate engagement of the tension bolt with the engagement surface of the engagement flange, and advantageously, the engagement flange defines an outer arcuate peripheral edge adjacent the engagement surface thereof.

68. A tool as claimed in claim 58 in which the central member of the alignment member defines a locating portion adjacent the proximal end thereof, the locating portion being adapted to engage a locating portion of the entry slot of the receiving groove of the tool holder for aligning the alignment member with the receiving groove.

69. A tool as claimed in claim 68 in which the locating portion of the central member of the alignment member is adapted to engage the locating portion of the entry slot of the receiving groove of the tool holder with a snug sliding fit, and preferably, the locating portion extends longitudinally along the central member of the alignment member a distance of at least 5 mm, and preferably, a distance of at least 10 mm, and advantageously, a distance of approximately 13 mm, and advantageously, the locating portion extends from the proximal end of the central member of the alignment member.

70. A tool as claimed in claim 68 in which the locating portion is of width in a transverse direction relative to the alignment plane greater than the transverse width of the central member of the alignment member from the distal end of the locating portion to the distal end of the central member, and preferably, the locating portion of the central member of the alignment member extends from the engagement face of the tool, and preferably, the locating portion of the central member of the alignment member extends from the engagement face of the tool to the respective side flanges of the alignment member, and advantageously, the locating portion of the central member of the alignment member is symmetrical about the alignment plane.

71. A tool as claimed in claim 68 in which the locating portion of the central member of the alignment member defines opposite locating faces thereof slideably and snugly engageable with corresponding faces of the entry slot of the receiving groove of the tool holder adjacent the proximal end thereof, and preferably, the body member of the tool extends longitudinally from a proximal end to a distal end.

72. A tool as claimed in claim 58 in which the proximal end of the alignment member substantially coincides with the proximal end of the body member of the tool, and preferably, the distal end of the alignment member is located intermediate the proximal and distal ends of the body member of the tool, and advantageously, the alignment member, including the engagement member and the engagement flange are of metal material, and preferably, the surfaces defined by the alignment member, the engagement member and the engagement flange are polished.

73. A tool as claimed in claim 58 in which the alignment means comprises a plurality of alignment pins extending from the abutment face of the tool and spaced apart along and defining the alignment plane, the alignment pins being adapted to engage the receiving groove of the tool holder, and preferably, the alignment means is adapted to cooperate with the receiving groove of the tool holder during entry of the tool in the tool holder for guiding the tool into the tool holder with the alignment means aligned with the receiving groove, and advantageously, the alignment means is adapted to cooperate with the receiving groove of the tool holder for aligning the tool with the tool holder from the commencement of entry of the alignment means into the tool holder, and preferably, the alignment means is adapted to cooperate with the receiving groove of the tool holder for aligning the tool with the tool holder from the commencement of engagement of the engagement member with the receiving groove of the tool holder.

74. A tool as claimed in claim 58 in which the main axis defined by the engagement member coincides with the centre of a working area of the working face of the tool.

75. A tool as claimed in claim 58 in which the working area of the working face of the tool comprises or is adapted to receive formations or components for forming, shaping or otherwise working a sheet of material to be formed, shaped or worked by the tool, and preferably, the tool is adapted for forming, shaping or working a film material, and advantageously, the tool is adapted for forming, shaping or working a film material in the blister packing of products.

76. A pair of tools, each tool comprising a tool as claimed in claim 58, the tools being adapted to cooperate with each other in the forming, shaping or working material by the working faces of the respective tools.

77. A pair of tools as claimed in claim 76 in which the tools are adapted to engage respective spaced apart tool holders with the tools configured to accommodate the material to be formed, shaped or worked therebetween, and preferably, the tools are adapted for engaging a corresponding pair of tool holders in a blister packing machine, and advantageously, the tools are adapted for engagement with a pair of tool holders of a blister packing machine for packing pharmaceutical solid dose healthcare products.
